(19) United States
(12) Patent Application Publication
(10) Pub. No.: US 2025/0324440 A1
(43) Pub. Date: Oct. 16, 2025

(54) TRANSMISSION DEVICE, TRANSMISSION METHOD, RECEPTION DEVICE, AND RECEPTION METHOD

(71) Applicant: Sony Group Corporation, Tokyo (JP)

(72) Inventor: Kazuyuki TAKAHASHI, Chiba (JP)

(73) Assignee: Sony Group Corporation, Tokyo (JP)

(21) Appl. No.: 18/863,181

(22) PCT Filed: May 30, 2023
(86) PCT No.: PCT/JP2023/020015

§ 371 Date: Nov. 5, 2024

(30) Foreign Application Priority Data
Jun. 1, 2022 (JP) 2022-089359

(51) Int. Cl. H04W 72/30; H04W 72/1263

(52) U.S. Cl. CPC H04W 72/30; H04W 72/1263

(57) ABSTRACT

There is provided a transmission device, a transmission method, a reception device, and a reception method that enable more appropriate transmission of time information. The transmission device includes: a generation unit that generates physical layer control information included in a physical layer frame; and a transmission unit that transmits the physical layer frame as a broadcast signal to which a layered division multiplexing system is applied, in which a broadcast signal of a first broadcast system is transmitted in a first hierarchical layer of the layered division multiplexing system, and a broadcast signal of a second broadcast system is transmitted in a second hierarchical layer of the layered division multiplexing system, and, of the physical layer control information, first physical layer control information included in the broadcast signal of the first broadcast system includes time information to be used in a synchronization process related to the broadcast signal of the second broadcast system. The present disclosure can be applied to a transmission system compatible with a broadcast system of digital terrestrial television broadcasting, for example.

### TECHNICAL FIELD

The present disclosure relates to a transmission device, a transmission method, a reception device, and a reception method, and more particularly, to a transmission device, a transmission method, a reception device, and a reception method capable of more appropriately transmitting time information.

### BACKGROUND ART

As a broadcast system of digital terrestrial television broadcasting, there is Integrated Services Digital Broadcasting-Terrestrial (ISDB-T) adopted by Japan and other countries. In Japan, studies are being conducted toward a more sophisticated next-generation digital terrestrial television broadcasting. As for technologies related to next-generation digital terrestrial television broadcasting, there are technologies disclosed in Patent Documents 1 and 2, for example.

Patent Document 1 discloses a technique for determining whether a broadcast included in a low-power hierarchical layer can be received when a digital terrestrial broadcast signal of the current ISDB-T and a next-generation digital terrestrial broadcast signal are subjected to layered division multiplexing as a high-power hierarchical layer and a low-power hierarchical layer, respectively, in the same frequency band, using a layered division multiplexing (LDM) system.

Patent Document 2 discloses a technique for increasing the transmission capacity without using any other frequency band by not incorporating information indicating that a data series of the other layer is multiplexed into a multiplexed signal, with respect to control information indicating the system used for transmitting a data series of one layer in a case where the layered division multiplexing system is used.

### CITATION LIST

### Patent Document

Patent Document 1: Japanese Patent Application Laid-Open No. 2020-150521

Patent Document 2: Japanese Patent Application Laid-Open No. 2018-101862

### SUMMARY OF THE INVENTION

### Problems to be Solved by the Invention

Patent Documents 1 and 2 disclose techniques for transmitting a terrestrial digital broadcast signal of the current ISDB-T and a next-generation digital terrestrial broadcast signal, using the layered division multiplexing system. However, Patent Literatures 1 and 2 do not disclose any technique related to transmission of time information to be used in a synchronization process, and there has been a demand for a proposal for more appropriately transmitting time information in a case where the layered division multiplexing system is used.

The present disclosure has been made in view of such circumstances, and is to enable more appropriate transmission of time information.

### Solutions to Problems

A transmission device according to one aspect of the present disclosure is a transmission device that includes: a generation unit that generates physical layer control information included in a physical layer frame; and a transmission unit that transmits the physical layer frame as a broadcast signal to which a layered division multiplexing system is applied, in which a broadcast signal of a first broadcast system is transmitted in a first hierarchical layer of the layered division multiplexing system, a broadcast signal of a second broadcast system is transmitted in a second hierarchical layer of the layered division multiplexing system, and, of the physical layer control information, first physical layer control information included in the broadcast signal of the first broadcast system includes time information to be used in a synchronization process related to the broadcast signal of the second broadcast system.

A transmission method according to one aspect of the present disclosure is a transmission method that is implemented by a transmission device, and includes: generating physical layer control information included in a physical layer frame; and transmitting the physical layer frame as a broadcast signal to which a layered division multiplexing system is applied, in which a broadcast signal of a first broadcast system is transmitted in a first hierarchical layer of the layered division multiplexing system, a broadcast signal of a second broadcast system is transmitted in a second hierarchical layer of the layered division multiplexing system; and, of the physical layer control information, time information to be used in a synchronization process related to the broadcast signal of the second broadcast system is included in first physical layer control information included in the broadcast signal of the first broadcast system.

In the transmission device and the transmission method according to one aspect of the present disclosure, physical layer control information included in a physical layer frame is generated, and the physical layer frame is transmitted as a broadcast signal to which a layered division multiplexing system is applied. Further, a broadcast signal of a first broadcast system is transmitted in a first hierarchical layer of the layered division multiplexing system, a broadcast signal of a second broadcast system is transmitted in a second hierarchical layer of the layered division multiplexing system, and first physical layer control information included in the broadcast signal of the first broadcast system in the physical layer control information includes time information to be used in a synchronization process related to the broadcast signal of the second broadcast system.

A reception device according to one aspect of the present disclosure is a reception device that includes: a reception unit that receives a physical layer frame transmitted as a broadcast signal to which a layered division multiplexing system is applied; and a processing unit that processes data obtained from the physical layer frame, in which a broadcast signal of a first broadcast system is transmitted in a first hierarchical layer of the layered division multiplexing system, a broadcast signal of a second broadcast system is transmitted in a second hierarchical layer of the layered division multiplexing system; and a synchronization process related to the broadcast signal of the second broadcast system is performed using time information included in first physical layer control information included in the broadcast signal of the first broadcast system, the first physical layer control information being of physical layer control information included in the physical layer frame.

A reception method according to one aspect of the present disclosure is a reception method that is implemented by a reception device, and includes: receiving a physical layer frame transmitted as a broadcast signal to which a layered division multiplexing system is applied; and processing data obtained from the physical layer frame, in which a broadcast signal of a first broadcast system is transmitted in a first hierarchical layer of the layered division multiplexing system, a broadcast signal of a second broadcast system is transmitted in a second hierarchical layer of the layered division multiplexing system; and a synchronization process related to the broadcast signal of the second broadcast system is performed using time information included in first physical layer control information included in the broadcast signal of the first broadcast system, the first physical layer control information being of physical layer control information included in the physical layer frame.

In the reception device and the reception method according to one aspect of the present disclosure, a physical layer frame transmitted as a broadcast signal to which a layered division multiplexing system is applied is received, and data obtained from the physical layer frame is processed. Further, a broadcast signal of a first broadcast system is transmitted in a first hierarchical layer of the layered division multiplexing system, a broadcast signal of a second broadcast system is transmitted in a second hierarchical layer of the layered division multiplexing system, and a synchronization process related to the broadcast signal of the second broadcast system is performed using time information included in first physical layer control information included in the broadcast signal of the first broadcast system, the first physical layer control information being of physical layer control information included in the physical layer frame.

A transmission device according to one aspect of the present disclosure is a transmission device that includes: a generation unit that generates physical layer control information included in a physical layer frame; and a transmission unit that transmits the physical layer frame as a broadcast signal to which a layered division multiplexing system is applied, in which a first stream including data of content is transmitted in a first hierarchical layer between the first hierarchical layer and a second hierarchical layer of the layered division multiplexing system, and the physical layer control information includes timeline synchronization information for synchronizing, in time series, data included in the first stream and data included in a second stream of a system different from the first stream.

A transmission method according to one aspect of the present disclosure is a transmission method that is implemented by a transmission device, and includes: generating physical layer control information included in a physical layer frame; and transmitting the physical layer frame as a broadcast signal to which a layered division multiplexing system is applied, in which a first stream including data of content is transmitted in a first hierarchical layer between the first hierarchical layer and a second hierarchical layer of the layered division multiplexing system; and the physical layer control information includes timeline synchronization information for synchronizing, in time series, data included in the first stream and data included in a second stream of a system different from the first stream.

In the transmission device and the transmission method according to one aspect of the present disclosure, physical layer control information included in a physical layer frame is generated, and the physical layer frame is transmitted as a broadcast signal to which a layered division multiplexing system is applied. Further, a first stream including data of content is transmitted in a first hierarchical layer between the first hierarchical layer and a second hierarchical layer of the layered division multiplexing system, and the physical layer control information includes timeline synchronization information for synchronizing, in time series, data included in the first stream and data included in a second stream of a system different from that of the first stream.

A reception device according to one aspect of the present disclosure is a reception device that includes: a reception unit that receives a physical layer frame transmitted as a broadcast signal to which a layered division multiplexing system is applied, and a processing unit that processes data obtained from the physical layer frame, in which a first stream including data of content is transmitted in a first hierarchical layer between the first hierarchical layer and a second hierarchical layer of the layered division multiplexing system, and a synchronization process for synchronizing, in time series, data included in the first stream and data included in a second stream of a system different from the first stream is performed using timeline synchronization information included in physical layer control information included in the physical layer frame.

A reception method according to one aspect of the present disclosure is a reception method that is implemented by a reception device, and includes: receiving a physical layer frame transmitted as a broadcast signal to which a layered division multiplexing system is applied, and processing data obtained from the physical layer frame, in which a first stream including data of content is transmitted in a first hierarchical layer between the first hierarchical layer and a second hierarchical layer of the layered division multiplexing system, and a synchronization process for synchronizing, in time series, data included in the first stream and data included in a second stream of a system different from the first stream is performed using timeline synchronization information included in physical layer control information included in the physical layer frame.

In the reception device and the reception method according to one aspect of the present disclosure, a physical layer frame transmitted as a broadcast signal to which a layered division multiplexing system is applied is received, and data obtained from the physical layer frame is processed. Further, a first stream including data of content is transmitted in a first hierarchical layer between the first hierarchical layer and a second hierarchical layer of the layered division multiplexing system, and a synchronization process of synchronizing, in time series, data included in the first stream and data included in a second stream of a system different from that of the first stream is performed using timeline synchronization information included in physical layer control information included in the physical layer frame.

Note that a transmission device and a reception device according to one aspect of the present disclosure may be independent devices, or may be internal blocks constituting one device.

### BRIEF DESCRIPTION OF DRAWINGS

FIG. 1 is a block diagram illustrating an example configuration of an embodiment of a transmission system to which the present disclosure is applied.

FIG. 2 is a block diagram illustrating an example configuration of a transmission device illustrated in FIG. 1.

FIG. 3 is a block diagram illustrating an example configuration of a reception device illustrated in FIG. 1.

FIG. 4 is a table showing an example of time information included in physical layer control information of an existing broadcast system.

FIG. 5 is a table showing an example of values of a leap second indicator of the time information.

FIG. 6 is a diagram illustrating the relationship between OFDM frames and the time information.

FIG. 7 is a table showing an example of seismic-motion alert information of the existing broadcast system.

FIG. 8 is a table showing the values of a start/end flag shown in FIG. 7.

FIG. 9 is a table showing an example of values of a start/end flag indicating presence or absence of time information.

FIG. 10 is a table showing a first example of bit allocation including time information in an AC signal of the existing broadcast system.

FIG. 11 is a table showing a second example of bit allocation including time information in an AC signal of the existing broadcast system.

FIG. 12 is a table showing an example of values of a start/end flag indicating extended control information.

FIG. 13 is a table showing an example of bit allocation including extended control information in an AC signal of the existing broadcast system.

FIG. 14 is a table showing an example of values of descriptor_tag of the extended control information.

FIG. 15 is a table showing a first example of bit allocation in a case where time information is provided as the extended control information.

FIG. 16 is a table showing a second example of bit allocation in a case where time information is provided as the extended control information.

FIG. 17 is a diagram illustrating an example configuration of a transmission system in a case where multistream transmission is adopted.

FIG. 18 is a table illustrating an example of bit allocation including timeline synchronization information in an AC signal of the existing broadcast system.

FIG. 19 is a table showing an example of values of descriptor_tag of the extended control information.

FIG. 20 is a table showing an example of bit allocation in a case where timeline synchronization information is provided as the extended control information.

FIG. 21 is a flowchart for explaining a flow of processing to be performed by the respective devices in the transmission system.

FIG. 22 is a block diagram illustrating an example configuration of a computer.

### MODE FOR CARRYING OUT THE INVENTION

### System Configuration

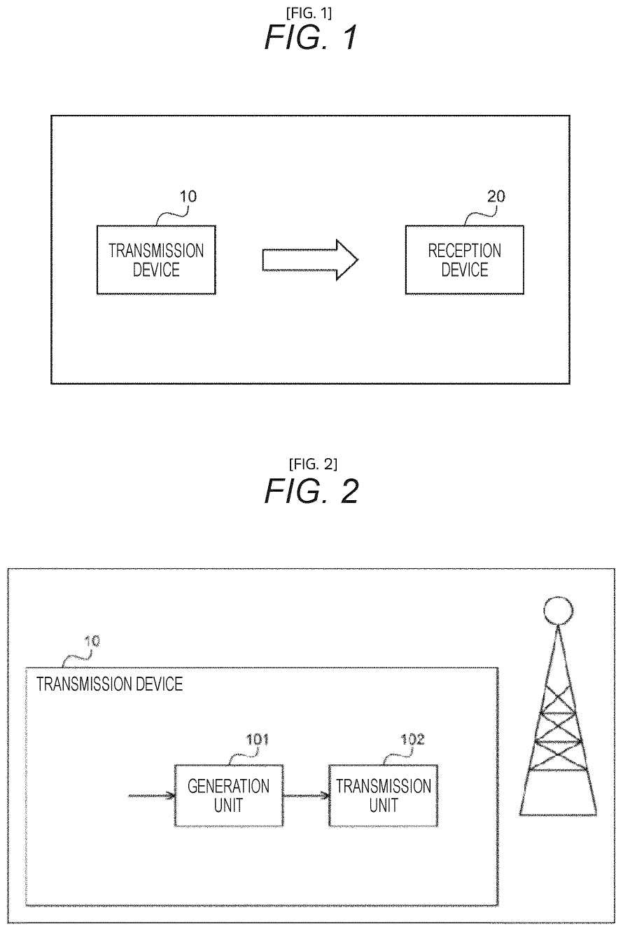

FIG. 1 is a block diagram illustrating an example configuration of an embodiment of a transmission system to which the present disclosure is applied.

In FIG. 1, the transmission system includes a transmission device 10 and a reception device 20. Note that the system is a logical assembly of a plurality of devices.

The transmission device 10 is a device that transmits content such as a broadcast program produced by a terrestrial broadcast station or a commercial message as a broadcast signal. The transmission device 10 generates a broadcast stream, performs necessary processing thereon, and transmits the resulting broadcast signal of digital terrestrial television broadcasting (hereinafter, the broadcast signal will also be referred to as the terrestrial broadcast signal) from a transmission antenna installed in a transmission station.

The reception device 20 is a device capable of receiving a broadcast signal, such as a television receiver or a set-top box (STB). The reception device 20 receives the terrestrial broadcast signal transmitted from the transmission device 10 via an antenna. The reception device 20 performs necessary processing on the broadcast stream obtained from the received terrestrial broadcast signal, to output the video image and sound of content such as a broadcast program.

FIG. 2 is a block diagram illustrating an example configuration of the transmission device 10 illustrated in FIG. 1. In FIG. 2, the transmission device 10 includes a generation unit 101 and a transmission unit 102.

The generation unit 101 generates control information such as transmission control information on the basis of data input thereto. In the description below, control information transmitted in a physical layer will be also referred to as physical layer control information to be distinguished from control information (upper-layer control information related to broadcast components, for example) transmitted in an upper layer (a transport layer, for example) that is a layer higher than the physical layer.

The generation unit 101 performs necessary processing on the broadcast stream input thereto, and adds the generated physical layer control information. By doing so, the generation unit 101 generates a physical layer frame compliant with the broadcast system of digital terrestrial television broadcasting, and supplies the physical layer frame to the transmission unit 102.

The broadcast stream includes the broadcast components constituting the content such as a broadcast program produced by a terrestrial broadcast station, upper-layer control information related to the broadcast components, and the like. The broadcast components includes components such as a video stream, an audio stream, and a subtitles stream.

The transmission unit 102 performs necessary processing such as a modulation process on the physical layer frame supplied from the generation unit 101, and transmits the physical layer frame as a terrestrial broadcast signal from the transmission antenna.

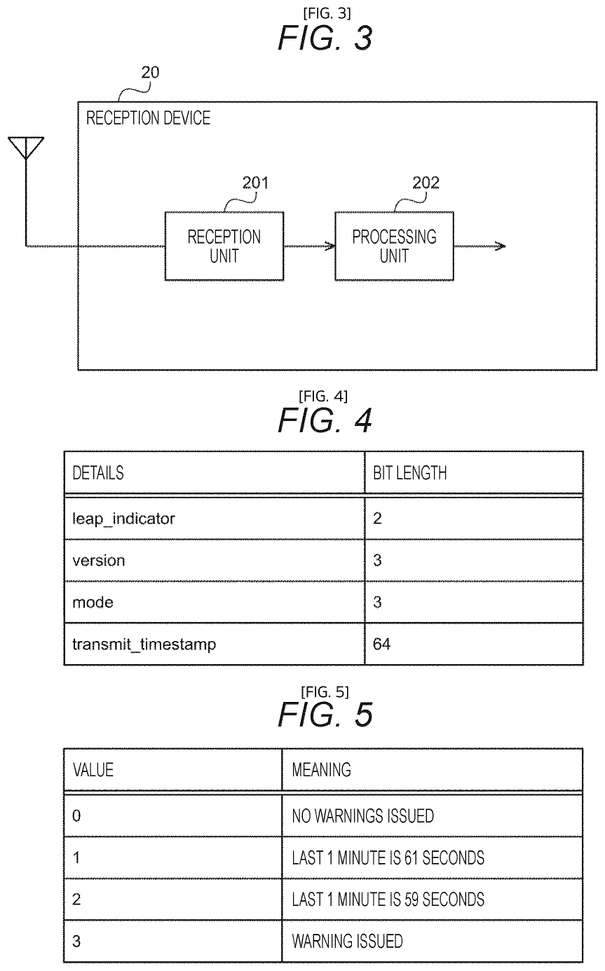

FIG. 3 is a block diagram illustrating an example configuration of the reception device 20 illustrated in FIG. 1. In FIG. 3, the reception device 20 includes a reception unit 201 and a processing unit 202.

The reception unit 201 includes a tuner, a demodulation device (a demodulation LSI, for example), or the like. The reception unit 201 performs necessary processing such as a demodulation process on the terrestrial broadcast signal received via the antenna, and acquires the physical layer control information included in the physical layer frame. The reception unit 201 performs necessary processing on the signal obtained from the physical layer frame on the basis of the acquired physical layer control information, and supplies a packet storing the resultant broadcast stream data to the processing unit 202.

The processing unit 202 includes a main system on chip (SoC) or the like. The processing unit 202 performs necessary processing such as a decoding process and a presentation process on the packet supplied from the reception unit 201.

Since the broadcast stream includes the broadcast components and the upper-layer control information, processing related to decoding, presentation, and the like of the broadcast component data is performed on the basis of the control information such as the upper-layer control information and the physical layer control information in the processing such as the decoding process and the presentation process. The video and audio data obtained by the processing such as the decoding process and the presentation process are output to subsequent circuits. As a result, in the reception device 20, the video image of the content such as a broadcast program is displayed on a display, and the sound synchronized with the video image is output from a speaker.

Note that, as for the above-described configuration illustrated in FIG. 1, an example case where the number of reception devices 20 is one has been described. However, a plurality of reception devices 20 is provided in practice, and each of them can receive and process a terrestrial broadcast signal transmitted from the transmission device 10. Note that, in the above-described configuration illustrated in FIG. 2, the transmission device 10 includes the generation unit 101 and the transmission unit 102. However, the generation unit 101 and the transmission unit 102 may be provided in different devices from each other. That is, the configuration illustrated in FIG. 2 may be a transmission system (a broadcast transmission system) formed with a first device including the generation unit 101 and a second device including the transmission unit 102.

### Broadcast System

In the above-described configuration, a broadcast system such as integrated services digital broadcasting-terrestrial (ISDB-T) can be used as the broadcast system of digital terrestrial television broadcasting, for example. Further, although ISDB-T is adopted in Japan, a next-generation system of digital terrestrial television broadcasting has been studied. In the configuration described above, a next-generation system of ISDB-T (a broadcast system for novel broadcasting, which will be hereinafter also referred to as a novel broadcast system) can be used as a broadcast system for digital terrestrial television broadcasting. The current ISDB-T is a broadcast system for the existing broadcasting, and it is safe to say that the current ISDB-T is an existing broadcast system.

In the novel broadcast system, an orthogonal frequency division multiplexing (OFDM) system is used as in the existing broadcast system, and application of a low density parity check (LDPC) code has been considered as an error correction code. That is, in the novel broadcast system, an OFDM frame is used as a physical layer frame as in the existing broadcast system.

Further, transmission of a broadcast signal of the novel broadcast system by applying a layered division multiplexing (LDM) system has been studied as a broadcast signal multiplexing system. In the configuration described above, in a case where the layered division multiplexing system is used, broadcast signals can be transmitted in a high-power hierarchical layer as an upper layer (UL) and a low-power hierarchical layer as a lower layer (LL).

For example, an operation in which a broadcast signal compatible with the existing broadcast system (ISDB-T) is transmitted in a high-power hierarchical layer (UL), and a broadcast signal of a novel broadcast system (the next-generation system of ISDB-T) is transmitted in a low-power hierarchical layer (LL) is assumed. Specifically, a broadcast signal including 2K content corresponding to a 2K video image is transmitted in the high-power hierarchical layer (UL), and a video signal including 4K content corresponding to a 4K video image is transmitted in the low-power hierarchical layer (LL), so that broadcast signals of 2K broadcasting and 4K broadcasting can be transmitted. As a result, in a case where the reception device 20 is compatible with the novel broadcast system, 4K content can be viewed. In a case where the reception device 20 is not compatible with the novel broadcast system, 2K content can be viewed.

### Time Information

In the above-described configuration illustrated FIG. 1, processing such as a synchronization process is performed by transmitting information regarding time (hereinafter referred to as the time information) from the transmission device 10 to the reception device 20. For example, the reception device 20 performs a synchronization process such as presentation synchronization, using the time information transmitted from the transmission device 10. As the reception device 20 performs presentation synchronization using the time information, it becomes possible to present, in synchronization, the video image and the audio data of the content transmitted from the transmission device 10.

In a case where the layered division multiplexing system is adopted, and a broadcast signal of the existing broadcast system is transmitted in a high-power hierarchical layer (UL) while a broadcast signal of the novel broadcast system is transmitted in a low-power hierarchical layer (LL), it is also necessary to transmit the time information. In particular, the transmission of the time information to be used in the synchronization process related to broadcast signals of the novel broadcast system in a case where the layered division multiplexing system is used is not disclosed in Patent Documents 1 and 2 described above, and there has been a demand for a proposal for transmitting the time information in a more appropriate manner.

In the system proposed in the present disclosure, the time information to be used in the synchronization process (presentation synchronization or the like) related to a broadcast signal of a novel broadcast system (a next-generation system of ISDB-T) is included in the physical layer control information included in a broadcast signal of an existing broadcast system (ISDB-T, for example), so that the time information is transmitted from the transmission device 10 to the reception device 20. Thus, the time information is appropriately transmitted, and the synchronization process using the time information can be performed.

FIG. 4 is a table showing an example of the time information included in physical layer control information of the existing broadcast system. In FIG. 4, the time information has a configuration in a network time protocol (NTP) format.

Two-bit leap_indicator represents a leap second indicator, and the leap_indicator is used when a leap second is inserted or deleted. FIG. 5 illustrates an example of values of the leap second indicator.

Three-bit “version” represents the version of NTP. When the version of NTP is 4, the “version” is set to 4. Three-bit “mode” represents the operation mode of NTP. In the transmission system in FIG. 1, a broadcast mode (mode=5) is used as the operation mode. Setting “version” and “mode” to fixed values (4 and 5, for example) eliminates the need to include the version and the mode in the time information, and the version and the mode do not need to be incorporated into the physical layer control information.

Sixty-four-bit transmit_timestamp represents time in an NTP format length as a transmission timestamp. Note that, in transmit_timestamp, the bits indicating an accuracy of second or less may be reduced from 32 bits to 24 bits (reduced by eight bits), and may be compressed to 56 bits, for example.

Note that details of the time information in the NTP format are disclosed in Document A shown below, for example.

### Document A: ARIB STD-B60 Version 1.6, Association of Radio Industries and Businesses

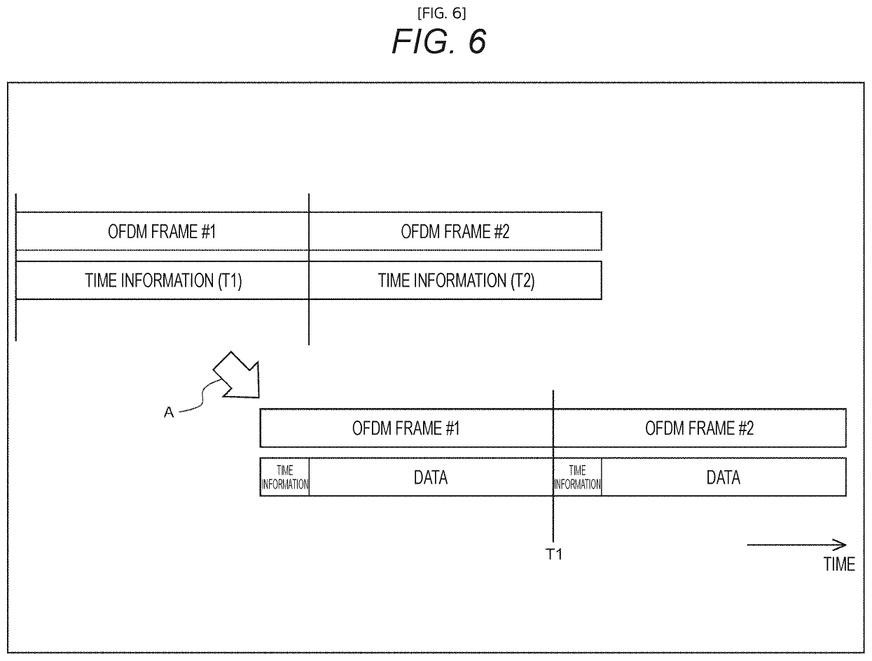

FIG. 6 is a diagram illustrating the relationship between OFDM frames and the time information. The upper portion of FIG. 6 (the upper side of an arrow A) schematically illustrates the relationship with the time information at the time of transmission an OFDM frame. The lower portion of FIG. 6 (the lower side of the arrow A) schematically illustrates the relationship with the time information during processing of an OFDM frame.

As illustrated in the upper portion of FIG. 6, the OFDM frames include the time information for the respective frames together with data. That is, the OFDM frames as physical layer frames include physical layer control information for the respective frames, and the time information is included for each piece of the physical layer control information in one frame.

An OFDM frame illustrated in the upper portion of FIG. 6 is transmitted from the transmission device 10 to the reception device 20, and, in the reception device 20, a demodulation process is performed by the reception unit 201 (a demodulation device). As illustrated in the lower portion of FIG. 6, the reception unit 201 performs a demodulation process, to acquire the time information and data from the OFDM frame. At this point of time, the time information indicates the time at the head of the OFDM frame following the OFDM frame including the time information.

Specifically, in the upper portion of FIG. 6, an OFDM frame #1 includes time information indicating time T1, and the next OFDM frame #2 includes time information indicating time T2. At this point of time, in the lower portion of FIG. 6, time T1 indicated by the time information included in the OFDM frame #1 indicates the time of the head of the next OFDM frame #2.

Here, the time information is the time information to be used in a synchronization process related to broadcast signals of the novel broadcast system that are transmitted in the low-power hierarchical layer (LL). Further, the time information can be included in broadcast signals of the existing broadcast system, which are OFDM frames that are transmitted in the high-power hierarchical layer (UL). That is, in a case where the layered division multiplexing system (LDM system) is used, broadcast signals can be transmitted in the high-power hierarchical layer (UL) and the low-power hierarchical layer (LL) by superimposing and transmitting radio waves having a level difference in the same frequency band. However, the time information to be used in the processing of the broadcast signal to be transmitted in the low-power hierarchical layer (LL) is included in the physical layer control information in the broadcast signal to be transmitted in the high-power hierarchical layer (UL).

In the reception device 20, a synchronization process related to the broadcast signal of the novel broadcast system is performed, using the time information obtained from the physical layer control information included in the broadcast signal of the existing broadcast system.

As the physical layer control information in which the time information is incorporated, an auxiliary channel (AC) signal specified in ISDB-T as the existing broadcast system can be used, for example. An AC signal is additional information related to broadcasting, and is used for specific applications such as earthquake early warnings. The same number of AC signals are present in all the segments. In the description below, an example of the layout of the time information in an AC signal as the physical layer control information is explained.

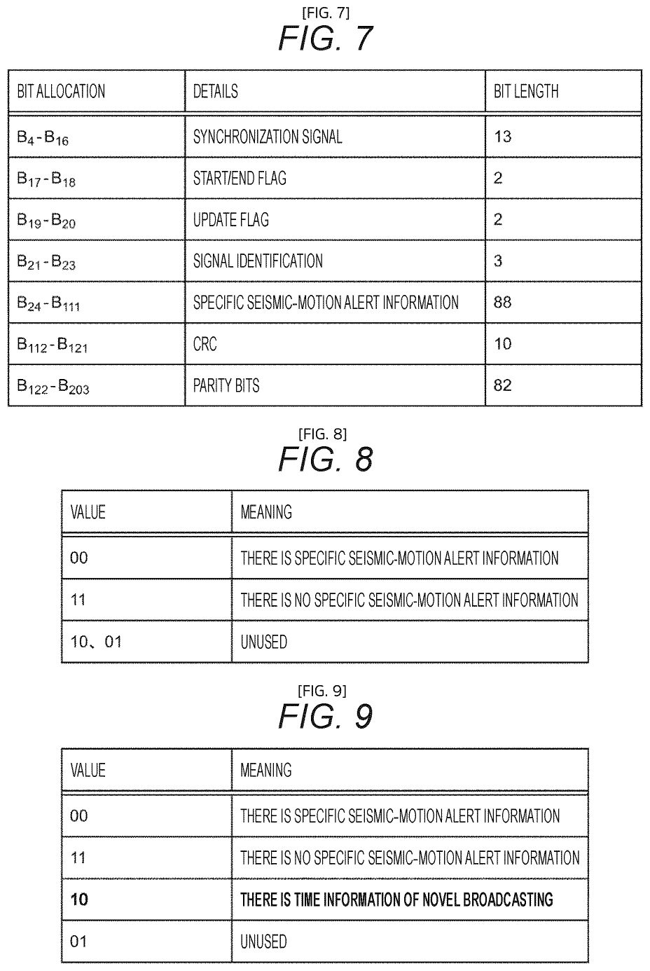

FIG. 7 is a table showing an example of seismic-motion alert information of the existing broadcast system. As shown in FIG. 7, among bits B₄ to B₂₀₃ of the seismic-motion alert information, a synchronization signal is allocated to the bits B₄ to B₁₆, a start/end flag is allocated to the bits B₁₇ and B₁₈, an update flag is allocated to the bits B₁₉ and B₂₀, signal identification is allocated to the bits B₂₁ to B₂₃, specific seismic-motion alert information is allocated to the bits B₂₄ to B₁₁₁, a cyclic redundancy check (CRC) is allocated to the bits B₁₁₂ to B₁₂₁, and parity bits are allocated to the bits B₁₂₂ to B₂₀₃.

FIG. 8 is a table showing the values of the start/end flag allocated to the two bits of the bits B₁₇ and B₁₈. As shown in FIG. 8, the start/end flag indicates that there is specific seismic-motion alert information when the value indicated by two bits “00” is designated, and indicates that there is no specific seismic-motion alert information when the value indicated by two bits “11” is designated. In the existing broadcast system, the values indicated by the two bits “10” and “01” remain unused.

Note that the details of seismic-motion alert information are disclosed in Document B shown below, for example.

### Document B: ARIB STD-B31 Version 2.2, Association of Radio Industries and Businesses

In the system proposed in the present disclosure, the unused values of the start/end flag shown in FIG. 8 are used to indicate the presence/absence of the time information of the novel broadcast system. FIG. 9 is a table showing an example of values of the start/end flag in the system proposed in the present disclosure. As shown in FIG. 9, when the value indicated by two bits “10” among the values indicated by the start/end flag is designated, there is time information of the novel broadcasting. The value indicated by two bits “01” remains unused.

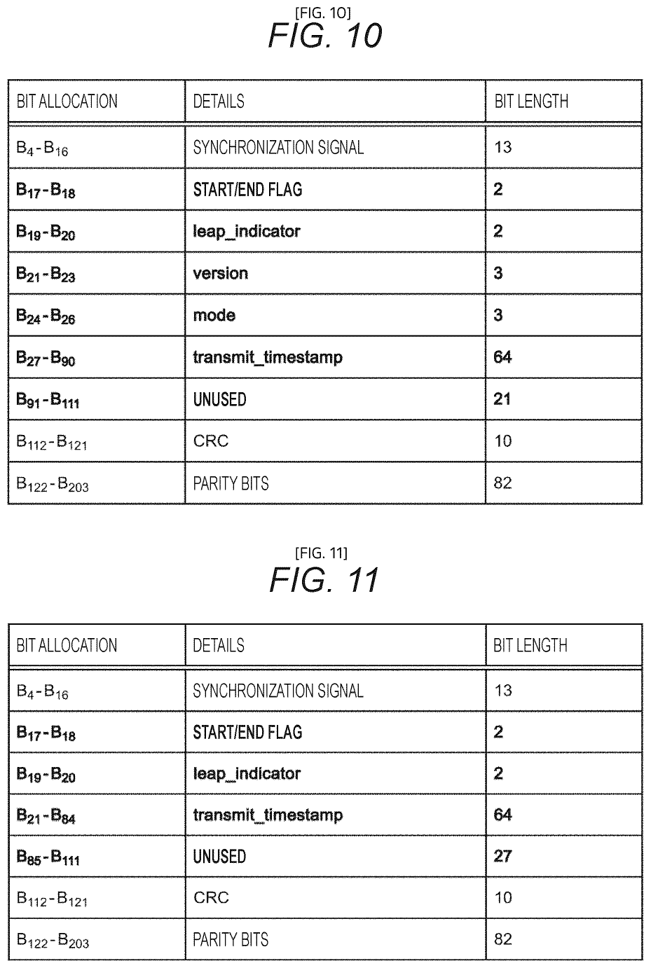

FIG. 10 is a table showing a first example of bit allocation including the time information in an AC signal of the existing broadcast system in a case where the system proposed in the present disclosure is adopted. This AC signal is transmitted in segment 0 (segment No. 0 to be the central part of the entire band) in a case where the value indicated by the two bits “10” is designated by the start/end flag of the bits B₁₇ and B₁₈ shown in FIG. 9, for example.

As shown in FIG. 10, among the bits B₄ to B₂₀₃ Of the AC signal, a synchronization signal is allocated to the bits B₄ to B₁₆, a start/end flag is allocated to the bits B₁₇ and B₁₈, leap_indicator is allocated to the bits B₁₉ and B₂₀, “version” is allocated to the bits B₂₁ to B₂₃, “mode” is allocated to the bits B₂₄ to B₂₆, transmit_timestamp is allocated to the bits B₂₇ to B₉₀, CRC is allocated to the bits B₁₁₂ to B₁₂₁, and parity bits are allocated to the bits B₁₂₂ to B₂₀₃. The bits B₉₁ to B₁₁₁ remain unused. The leap_indicator, “version”, “mode”, and transmit_timestamp correspond to the configuration of the NTP format shown in FIG. 4.

Note that, as described above, “version” and “mode” can be set to fixed values (4 and 5, for example), and, in that case, there is no need to transmit information regarding the version and the operation mode of the NTP, and bit allocation illustrated in FIG. 11 is performed, for example. In the bit allocation in FIG. 11, as compared with the bit allocation in FIG. 10, the 3-bit “version” and the 3-bit “mode” are excluded, and the number of unused bits is increased by six to be 27.

### Extended Control Information

In the example described above, the unused area of the seismic-motion alert information transmitted through an AC signal is extended to indicate the presence/absence of the time information, and the time information is transmitted. However, the time information is not necessarily transmitted, and extended control information of the novel broadcast system may be transmitted.

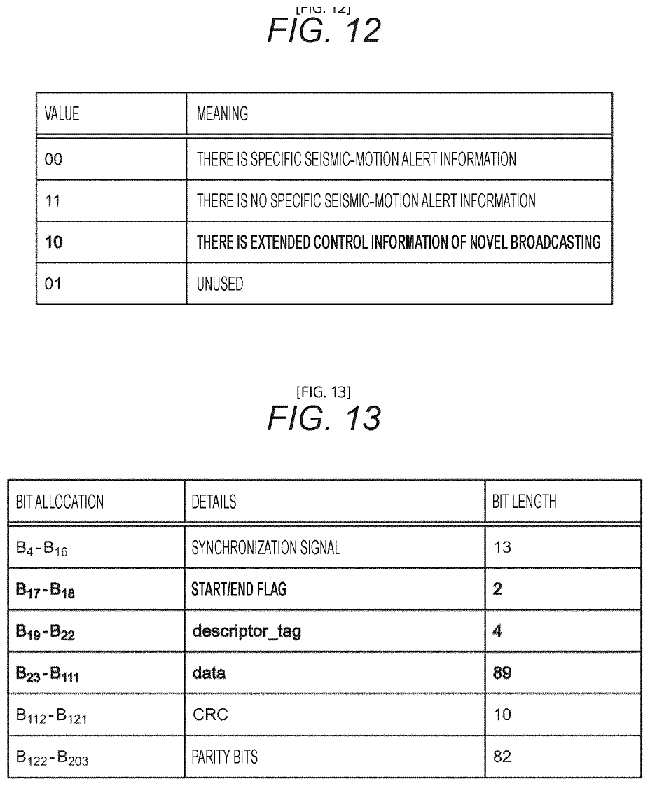

FIG. 12 is a table showing another example of values of the start/end flag in the system proposed in the present disclosure. In the system proposed in the present disclosure, the unused values of the start/end flag shown in FIG. 8 are used to indicate the presence/absence of the extended control information of the novel broadcast system. As shown in FIG. 12, when the value indicated by the two bits “10” among the values indicated by the start/end flag is designated, there is extended control information of the novel broadcasting.

FIG. 13 is a table showing an example of bit allocation including the extended control information in an AC signal of the existing broadcast system in a case where the system proposed in the present disclosure is adopted. This AC signal is transmitted in segment 0 in a case where the value indicated by the two bits “10” is designated by the start/end flag of the bits B₁₇ and B₁₈ shown in FIG. 12, for example.

As shown in FIG. 13, among the bits B₄ to B₂₀₃ Of the AC signal, a synchronization signal is allocated to the bits B₄ to B₁₆, a start/end flag is allocated to the bits B₁₇ and B₁₈, descriptor_tag is allocated to the bits B₁₉ to B₂₂, “data” is allocated to the bits B₂₃ to B₁₁₁, CRC is allocated to the bits B₁₁₂ to B₁₂₁, and parity bits are allocated to the bits B₁₂₂ to B₂₀₃. The 4-bit descriptor_tag indicates the type of the subsequent 89-bit data, to enable transmission of data such as a plurality of kinds of control information as the extended control information, in addition to the time information.

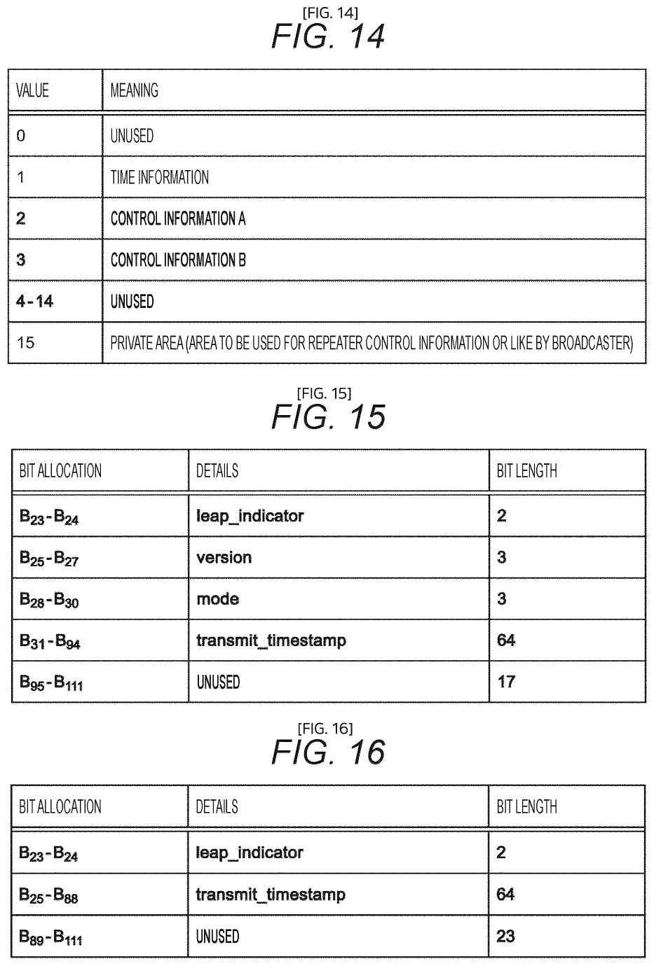

FIG. 14 is a table showing an example of values of descriptor_tag allocated to the bits B₁₉ to B₂₂. As shown in FIG. 14, when a value of 1 is designated among the values represented by the four bits of descriptor_tag, time information is provided as data. The time information can be formed in the NTP format shown in FIG. 4.

When a value of 2 is designated among the values represented by the four bits of descriptor_tag, control information A is provided as data, and, when a value of 3 is designated, control information B is provided as data. The control information A and the control information B are different control information, and are used in processing by the reception device 20. Note that the number of kinds of control information is not limited to two, and may be three or larger. In a case where three or more kinds of control information are used, an unused bit is allocated to each piece of the control information.

A private area is allocated to a value of 15 among the values represented by the four bits of descriptor_tag. The private area is an area to be used by the broadcaster, and can designate unique information. For example, information (repeater control information) to be used by the broadcaster to control a repeater can be provided in the private area. Note that values of 0 and 4 to 14 that can be designated by the four bits of descriptor_tag remain unused.

FIGS. 15 and 16 show examples of bit allocation in the time information provided as the extended control information in the bits B₂₃ to B₁₁₁ of the subsequent data when a value of 1 is designated as the value of descriptor_tag.

As shown in FIG. 15, among the bits B₂₃ to B₁₁₁ Of the data, leap_indicator is allocated to the two bits of the bits B₂₃ and B₂₄, “version” is allocated to the three bits of the bits B₂₅ to B₂₇, “mode” is allocated to the three bits of the bits B₂₈ to B₃₀, and transmit_timestamp is allocated to the 64 bits of the bits B₃₁ to B₉₄. The 17 bits of the bits B₉₅ to B₁₁₁ remain unused. The leap_indicator, “version”, “mode”, and transmit_timestamp correspond to the configuration in the NTP format shown in FIG. 4.

In a case where “version” and “mode” are fixed values (4 and 5, for example), the bit allocation shown in FIG. 16 is performed, for example. In the bit allocation in FIG. 16, the 3-bit version and the 3-bit mode are excluded, and the number of unused bits is increased by six to be 23, as compared with the bit allocation in FIG. 15.

As described above, in the system proposed in the present disclosure, in a case where the layered division multiplexing system is used, the time information and the extended control information of the novel broadcast system can be provided in the physical layer control information of the existing broadcast system and be transmitted. When the time information and the extended control information are provided in the physical layer control information, an unused area excluding the area used by the seismic-motion alert information of an AC signal is provided in the extended area, for example, so that information related to the novel broadcast system (the next-generation system of ISDB-T), such as the time information and the extended control information, can be transmitted without affecting the existing broadcast system (ISDB-T). Further, as the extended control information can be provided in a section structure, transmission of a plurality of kinds of control information and the time information is enabled, and future extension can be realized.

Note that, in the above description, an AC signal specified in the existing broadcast system (ISDB-T) has been explained as the physical layer control information in which the time information and the like of the novel broadcast system are provided. However, the time information and the like of the novel broadcast system may be provided in some other unused AC signal or some other unused undefined area. Alternatively, the time information and the like of the novel broadcast system may be provided in some other physical layer control information such as a transmission multiplexing configuration control (TMCC) signal specified in ISDB-T, and be transmitted. Although the seismic-motion alert information disclosed in Document B mentioned above is provided only in segment 0, the same information may be provided in some other segment.

### Other Example Configurations

In the above description, a configuration in which time information (time information in the NTP format) of a novel broadcast system (a next-generation system of ISDB-T) is provided in physical layer control information (an AC signal) of an existing broadcast system (ISDB-T) and is transmitted has been described. However, the configuration is not limited to that in which time information in the NTP format is transmitted from the transmission device 10, but may be a configuration in which the side of the reception device 20 converts time information into time information in the NTP format.

Specifically, the transmission device 10 generates physical layer control information including physical layer time information, and transmits the physical layer control information included in a physical layer frame. The physical layer time information is time information in a predetermined format (that is not the NTP format). Note that the physical layer time information is not necessarily time information in the predetermined format, and may be control information such as extended control information.

In the reception device 20, the reception unit 201 converts the physical layer time information included in the physical layer control information obtained from the physical layer frame received from the transmission device 10 into time information in the NTP format, and outputs the time information to the processing unit 202 in synchronization with an OFDM frame. That is, in a case where the layered division multiplexing system is used, the side of the reception device 20 converts the physical layer time information included in the physical layer control information into the time information in the NTP format as the time information of the novel broadcast system.

For example, the reception unit 201 (a demodulation device) outputs a packet (an IP packet or the like) storing the time information in the NTP format obtained by the conversion to the processing unit 202 (a main SoC) together with a packet (an IP packet or the like) storing the data obtained from the OFDM frame, so that the processing unit 202 can process the data on the basis of the time information in the NTP format. At this point of time, as illustrated in FIG. 6, the time information in the NTP format obtained by the conversion represents the time at the head of the next OFDM frame, and is output in synchronization with the OFDM frame. As a result, the existing reception device 20 (an existing receiver compatible with advanced BS digital broadcasting) can easily perform a synchronization process (presentation synchronization) related to a broadcast signal of the novel broadcast system, for example.

### Multistream Transmission

A multistream technology for increasing the video quality of content that is transmitted by an existing broadcasting system has been proposed. For example, in MPEG-5 Part2 Low Complexity Enhancement Video Coding (LCEVC), the video quality of the same content can be changed with a base stream and an enhancement stream. In a case where multistream transmission is performed with the layered division multiplexing (LDM) system, the base stream can be transmitted with a high-power hierarchical layer (UL) as a base layer, and the enhancement stream can be transmitted with a low-power hierarchical layer (LL) as an enhancement layer. The base stream that is transmitted in the high-power hierarchical layer (UL) provides a low-resolution video image (a 2K video image), and the addition of additional data by the enhancement stream that is transmitted in the low-power hierarchical layer (LL) provides a high-resolution video image (a 4K video image).

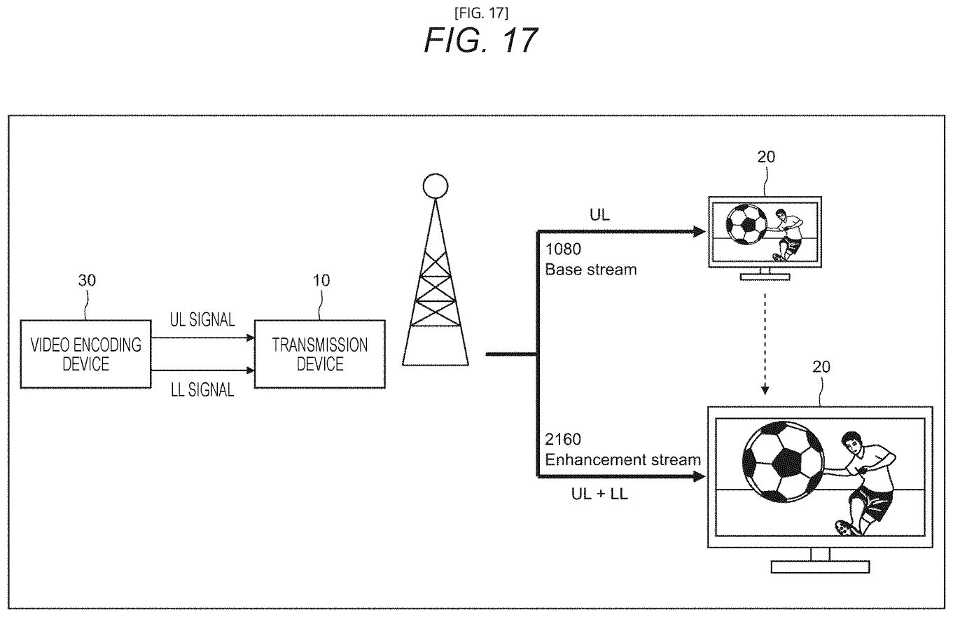

FIG. 17 is a diagram illustrating an example configuration of a transmission system in a case where multistream transmission is adopted. In FIG. 17, a video encoding device 30 divides and encodes data so that the data of a 2K video image of content such as a broadcast program can be transmitted in the high-power hierarchical layer (UL), and the additional data for a 4K video image of the same content (data for increasing the resolution and enhancing the video quality) can be transmitted in the low-power hierarchical layer (LL). The video encoding device 30 supplies the UL signal and the LL signal obtained by the encoding to the transmission device 10. The transmission device 10 transmits the UL signal and the LL signal supplied from the video encoding device 30 by the layered division multiplexing. That is, the UL signal including the 2K video data is transmitted by the base stream in the high-power hierarchical layer (UL), and the LL signal including the additional data for the 4K video image is transmitted by the enhancement stream in the low-power hierarchical layer (LL).

In a case where the reception device 20 is a television receiver with which 2K content can be viewed, when a user selects desired content, the reception device 20 receives and decodes the UL signal transmitted by the base stream in the high-power hierarchical layer (UL), and displays a 2K video image (with a screen resolution of 1920×1080 pixels, for example) of the selected content. Further, in a case where the reception device 20 is a television receiver with which 4K content can be viewed, when a user selects desired content, the reception device 20 receives and decodes the UL signal transmitted by the base stream in the high-power hierarchical layer (UL) and the LL signal transmitted by the enhancement stream in the low-power hierarchical layer (LL), and displays a 4K video image (with a screen resolution of 3840×2160 pixels, for example) of the selected content. As described above, in the transmission system in FIG. 17, 2K content can be provided as the existing broadcast system, and the 4K content can be provided as the novel broadcast system. In a case where the reception device 20 is compatible with the novel broadcast system, 4K content can be viewed. In a case where the reception device 20 is not compatible with the novel broadcast system, 2K content can be viewed.

For example, the base stream that is transmitted in the high-power hierarchical layer (UL) is an MPEG2-TS (transport stream) stream, and a packet in the MPEG2-TS format (a TS packet) is transmitted. Meanwhile, the enhancement stream that is transmitted in the low-power hierarchical layer (LL) is a stream of MMT/TLV, and a packet in the Internet Protocol (IP) format (an IP packet) is transmitted. An MPEG media transport (MMT) is a media transport system suitable for content distribution using various networks such as broadcasting and communication, and specifies a format and a transmission protocol for handling video images, sound, and the like, control information indicating the configuration of content, and the like. Type Length Value (TLV) is one of the methods for transmitting an IP packet by broadcasting, and the use of the TLV multiplexing system enables efficiently multiplexing of IP packets.

In an MPEG2 system, Program Clock Reference (PCR) is used as time information that is transmitted from the transmission side to the reception side. On the other hand, in an MMT/TLV system, coordinated universal time (UTC) in the Network Time Protocol (NTP) format is used as time information. That is, while the PCR is used in the base stream, UTC in the NTP format is used in the enhancement stream. Here, the PCR and the UTC with different references are not synchronized, and the system clock references are different. Therefore, the reception device 20 cannot synchronously reproduce a plurality of streams transmitted by different systems. That is, in an MPEG2 system adopted in the existing broadcast system, a PCR is generated by a 33-bit counter based on a 27 MHZ clock in the system. On the other hand, in a new system adopted to realize the novel broadcast system, the UTC in the NTP format is used as time information, and the time reference is different. Therefore, synchronization with the PCR cannot be obtained.

In the present disclosure, the UTC in the NTP format corresponding to the PCR is included as time information in the physical layer control information to be transmitted in the high-power hierarchical layer (UL) in the layered division multiplexing, so that the reception device 20 can synchronously reproduce a plurality of streams transmitted by different systems. That is, in the present disclosure, in a case where the base stream (an MPEG2-TS stream) is transmitted in the high-power hierarchical layer (UL) and the enhancement stream (an MMT/TLV stream) is transmitted in the low-power hierarchical layer (LL) with the layered division multiplexing system, the UTC in the NTP format corresponding to the PCR is repeatedly transmitted with the physical layer control information to be transmitted in the high-power hierarchical layer (UL) to synchronize signals of multiple streams to be transmitted in different transport layers. As a result, in the reception device 20, synchronization of a plurality of streams is realized by timeline synchronization, and 4K content can be viewed. It is safe to say that the UTC in the NTP format that corresponds to the PCR and is repeatedly transmitted with the physical layer control information is time information for synchronizing data included in a plurality of streams (data included in an MPEG2-TS stream to be transmitted in the high-power hierarchical layer (UL) and data included in an MMT/TLV stream to be transmitted in the low-power hierarchical layer (LL)) in time series, and also is timeline synchronization information.

Note that, in the above description, a case where both the base stream and the enhancement stream are transmitted through broadcast (a broadcast path) has been described. However, content transmitted through communication (a communication path) such as the Internet can be handled in a similar manner. That is, the reception device 20 can use the timeline synchronization information included in the physical layer control information to be transmitted via broadcasting, to synchronize the data included in the stream to be transmitted via broadcasting with the data included in the stream to be transmitted via communication in time series. For example, the stream to be transmitted by broadcasting is an MPEG2-TS stream. On the other hand, the stream to be transmitted through communication may be a stream including additional data for enhancing the video quality of the content to be transmitted by broadcasting, or may be a stream including data using UTC in the NTP format as time information, such as text information (subtitles, for example) to which time information is added, for example. Also, in the above description, a case where MMT is used as the media transport system, has been described. However, some other system, such as MPEG-DASH (Dynamic Adaptive Streaming over HTTP), may be used. Further, the TLV multiplexing system is not necessarily used, but some other system for transmitting IP packets by broadcasting may be used.

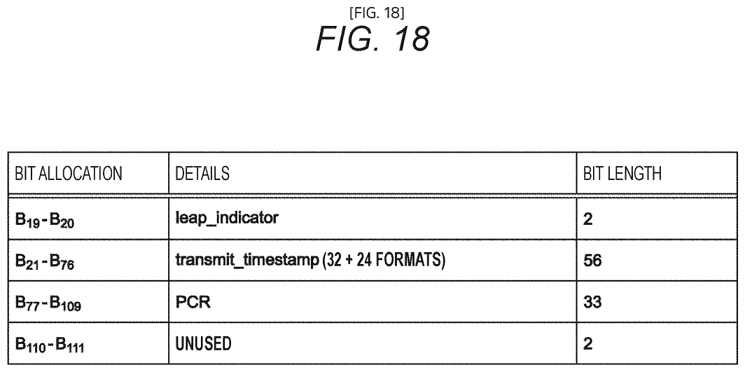

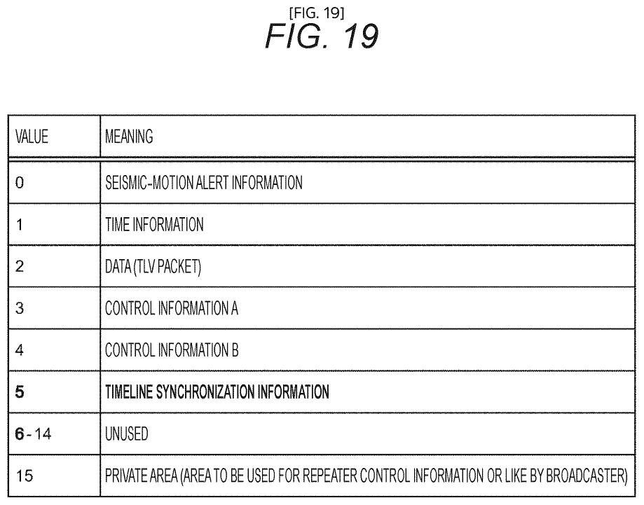

As the physical layer control information in which the timeline synchronization information is included, an AC signal of the existing broadcast system to be transmitted in the high-power hierarchical layer (UL) can be used, for example. FIG. 18 is a table illustrating an example of bit allocation including the timeline synchronization information in an AC signal of the existing broadcast system. The bit allocation in FIG. 18 corresponds to the bit allocation in FIG. 10, and shows the details of the bits B₁₉ to B₁₁₁. As shown in FIG. 18, leap_indicator is allocated to the bits B₁₉ and B₂₀, transmit_timestamp is allocated to the bits B₂₁ to B₇₆, and PCR is allocated to the bits B₇₇ to B₁₀₉. The bits B₁₁₀ and B₁₁₁ remain unused.

The 2-bit leap_indicator represents a leap second indicator. Values of the leap second indicator are as shown in FIG. 5. The 56-bit transmit_timestamp represents time in a NTP format length as a transmission timestamp. Here, a format in which the bits representing an accuracy of second or less are reduced from 32 bits to 24 bits, and are compressed to 56 bits is adopted. The 33-bit PCR represents the PCR generated by a 33-bit counter based on a 27 MHz clock. In the physical layer control information, transmit_timestamp is associated with the PCR, so that the UTC in the NTP format compatible with the PCR can be transmitted as the timeline synchronization information.

The timeline synchronization information may be transmitted in a manner similar to that for the extended control information shown in FIGS. 12 to 16 described above. FIG. 19 is a table illustrating an example of values of descriptor_tag allocated to the bits B₁₉ to B₂₂ of the AC signal shown in FIG. 13. As shown in FIG. 19, when a value of 5 is designated among values represented by the 4 bits of descriptor_tag, timeline synchronization information is provided as the data allocated to the bits B₂₃ to B₁₁₁ of the AC signal shown in FIG. 13.

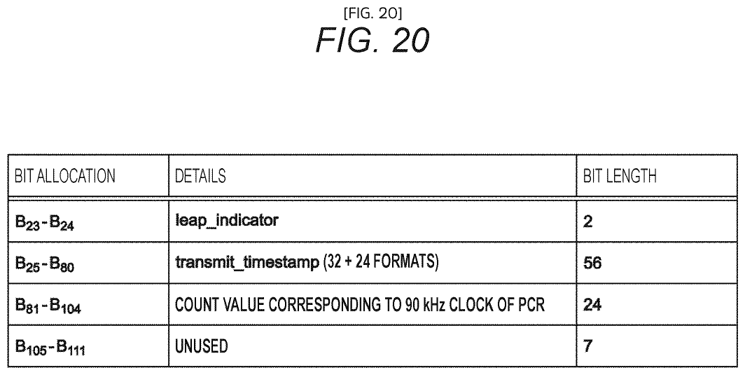

FIG. 20 shows an example of bit allocation in the timeline synchronization information provided as the extended control information in the bits B₂₃ to B₁₁₁ of the subsequent data when a value of 5 is designated as the value of descriptor_tag. As shown in FIG. 20, leap_indicator is allocated to the bits B₂₃ and B₂₄, transmit_timestamp is allocated to the bits B₂₅ to B₈₀, and the PCR is allocated to the bits B₈₁ to B₁₀₄. The bits B₁₀₅ to B₁₁₁ remain unused. The 2-bit leap_indicator represents a leap second indicator. The 56-bit transmit_timestamp represents time in a NTP format length as a transmission timestamp. The 24 bit PCR indicates a count value corresponding to a 90 KHz clock of the PCR. In the extended control information, transmit_timestamp is associated with the PCR, so that the UTC in the NTP format compatible with the PCR can be transmitted as the timeline synchronization information.

As described above, in the present disclosure, the timeline synchronization information can be handled as part of the time information, and can be included in the physical layer control information when transmitted. Thus, even in a case where streams of different systems are transmitted in the high-power hierarchical layer (UL) and the low-power hierarchical layer (LL) with the layered division multiplexing (LDM) system, the reception device 20 can synchronously reproduce the data included in the received streams of the different systems, using the timeline synchronization information. Further, even in a case where one of the streams of the different systems is transmitted by communication, a synchronization process can be performed in a similar manner using the timeline synchronization information.

### Flow of Processing by Each Device

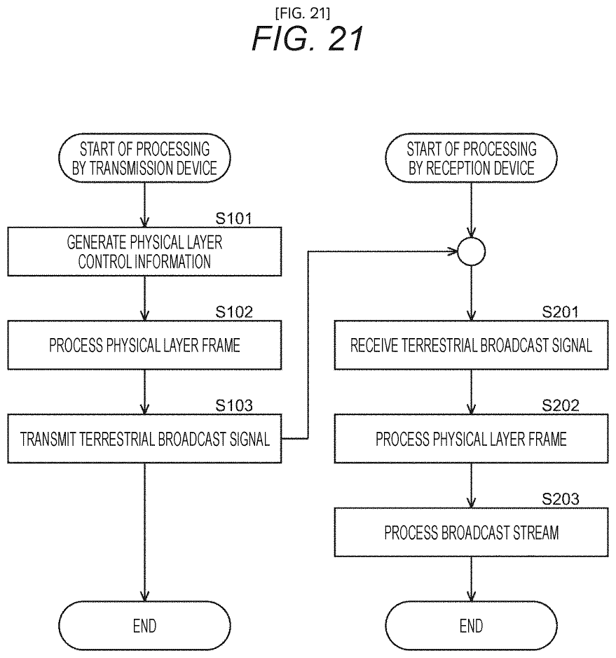

Next, a flow of processing to be performed by each device in the transmission system is described with reference to a flowchart shown in FIG. 21.

First, processes in steps S101 to S103 to be performed by the transmission device 10 are described. In step S101, the generation unit 101 generates physical layer control information such as a TMCC signal or an AC signal.

In step S102, the generation unit 101 generates a physical layer frame including the physical layer control information. In step S103, the transmission unit 102 performs necessary processing on the physical layer frame, and transmits the physical layer frame as a terrestrial broadcast signal from the transmission antenna. The physical layer frame is an OFDM frame, for example. As the broadcast signal multiplexing system, the layered division multiplexing system is used, a broadcast signal of the existing broadcast system is transmitted in the high-power hierarchical layer (UL), and a broadcast signal of the novel broadcast system is transmitted in the low-power hierarchical layer (LL).

The physical layer control information included in the physical layer frame to be transmitted in the high-power hierarchical layer (UL) can include time information. Further, timeline synchronization information can be included as the time information.

Next, processes in steps S201 to S203 to be performed by the reception device 20 are described. In step S201, the reception unit 201 receives the terrestrial broadcast signal transmitted from the transmission device 10 via an antenna.

In step S202, the reception unit 201 processes the physical layer frame obtained from the terrestrial broadcast signal. When processing of a signal obtained from the physical layer frame is performed, processing using the physical layer control information such as a TMCC signal or an AC signal is performed.

In step S203, the processing unit 202 processes a packet storing the data of a broadcast stream. Here, processing such as decoding and presentation of the broadcast component data is performed through a decoding process, a presentation process, and the like.

Further, although the layered division multiplexing system is used as the broadcast signal multiplexing system, the physical layer control information (AC signal) included in the broadcast signal of the existing broadcast system (ISDB-T) includes the time information (time information in the NTP format) to be used in the synchronization process related to the broadcast signal of the novel broadcast system (the next-generation system of ISDB-T). The reception device 20 performs a synchronization process (presentation synchronization and the like) on the broadcast signal of the novel broadcast system (the next-generation system of ISDB-T), using the time information (time information in the NTP format) included in the physical layer control information (AC signal). For example, in the reception device 20, the presentation synchronization is performed by setting the decoding time, the presentation time, and the like for each presentation unit of the video and audio data of the content of the novel broadcasting, on the basis of the time information in the NTP format included in the AC signal of the existing broadcasting. Note that the presentation synchronization using the time information in the NTP format is described in Document A mentioned above. In a case where the timeline synchronization information is included in the physical layer control information included in the physical layer frame to be transmitted in the high-power hierarchical layer (UL), the reception device 20 can perform a synchronization process of synchronizing the data included in the base stream (a stream including a TS packet) transmitted in the high-power hierarchical layer (UL) and the data transmitted in the enhancement stream (a stream including an IP packet) transmitted in the low-power hierarchical layer (LL) in time series, using the timeline synchronization information (the UTC in the NTP format corresponding to the PCR to be used in the MPEG2-TS format). Note that the stream including an IP packet is not necessarily transmitted through broadcasting, and may be transmitted through communication. In a case that the stream including an IP packet is transmitted through communication, the MPEG2-TS stream (the stream including a TS packet) to be transmitted through broadcasting may be transmitted not using the layered division multiplexing system.

### Modifications

In the above description, ISDB-T has been explained as a broadcast system of digital terrestrial television broadcasting, but the present disclosure may be applied to other broadcast systems. For example, other broadcast systems include a system compliant with Advanced Television Systems Committee (ATSC). Furthermore, the present disclosure is not limited to ground waves (terrestrial broadcasting), but may be applied to a broadcast system such as broadcasting satellites (BS), communications satellites (CS), or wired broadcasting using cables (Common Antenna Television (CATV)), for example.

In the above description, the reception device 20 has been explained as a stationary receiver such as a television receiver or a set-top box (STB), but the stationary receiver may be an electronic apparatus such as a recorder, a game machine, or a personal computer (PC), for example. Further, the reception device 20 is not necessarily a stationary receiver, but may be an electronic apparatus such as a mobile receiver like a smartphone, a mobile phone, or a tablet computer, an in-vehicle device mounted on a vehicle like an in-vehicle television receiver, or a wearable computer like a head-mounted display (HMD), for example.

Furthermore, in a transmission system to which the present disclosure is applied, a server having various functions connected to a communication line such as the Internet may be provided, so that the reception device 20 having a communication function can access the server via the communication line to perform bidirectional communication, and receive and process various kinds of data such as content and applications.

In the present specification, a “2K video image” is a video image compatible with a screen resolution of approximately 1920×1080 pixels, and a “4K video image” is a video image compatible with a screen resolution of approximately 3840×2160 pixels. Further, in the above description, 2K content of a 2K video image to be transmitted through the existing broadcasting, and 4K content of a 4K video image to be transmitted through the novel broadcasting have been explained as content. However, in the novel broadcasting, content with a higher image quality such as an 8K video image may be transmitted. An “8K video image” is a video image compatible with a screen resolution of approximately 7680×4320 pixels.

### Configuration of a Computer

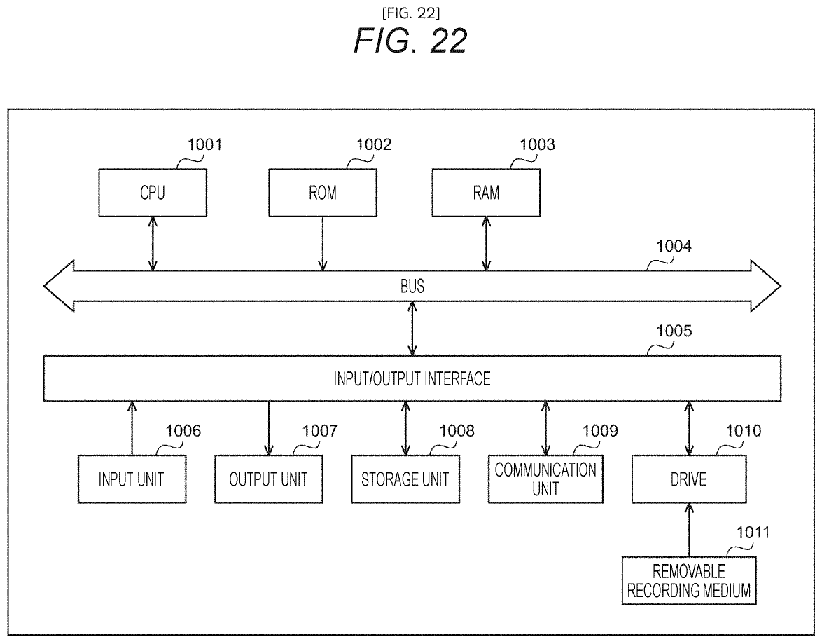

The series of processes described above can be performed by hardware or by software. In a case where the series of processes is performed by software, a program forming the software is installed into a computer. FIG. 22 is a block diagram illustrating an example configuration of the hardware of a computer that performs the above-described series of processes in accordance with a program.

In the computer, a central processing unit (CPU) 1001, a read only memory (ROM) 1002, and a random access memory (RAM) 1003 are connected to one another by a bus 1004. An input/output interface 1005 is further connected to the bus 1004. An input unit 1006, an output unit 1007, a storage unit 1008, a communication unit 1009, and a drive 1010 are connected to the input/output interface 1005.

The input unit 1006 is formed with a keyboard, a mouse, a microphone, and the like. The output unit 1007 is formed with a display, a speaker, and the like. The storage unit 1008 is formed with a hard disk, a non-volatile memory, and the like. The communication unit 1009 is formed with a network interface and the like. The drive 1010 drives a removable recording medium 1011 such as a semiconductor memory, a magnetic disk, an optical disk, or a magneto-optical disk.

In the computer designed as described above, the CPU 1001 loads a program recorded in the ROM 1002 or the storage unit 1008 into the RAM 1003 via the input/output interface 1005 and the bus 1004, and executes the program, to perform the above-described series of processes.

The program to be executed by the computer (the CPU 1001) can be recorded on the removable recording medium 1011 as a packaged medium or the like, for example, and be provided. Further, the program can be provided via a wired or wireless transmission medium such as a local area network, the Internet, or digital satellite broadcasting.

In the computer, the program can be installed into the storage unit 1008 via the input/output interface 1005 when the removable recording medium 1011 is mounted to the drive 1010. Also, the program can be received by the communication unit 1009 via a wired or wireless transmission medium, and be installed into the storage unit 1008. Alternatively, the program can be installed into the ROM 1002 or the storage unit 1008 in advance.

Here, in the present specification, the processes to be performed by the computer in accordance with a program are not necessarily performed in time series according to the sequence shown in the flowchart. In other words, the processes to be performed by the computer in accordance with a program include processes to be performed in parallel or independently (parallel processes or object-based processes, for example). Further, a program may be executed by one computer (processor), or may be executed by a plurality of computers in a distributed manner.

Note that embodiments of the present disclosure are not limited to the embodiment described above, and various modifications may be made without departing from the scope of the present disclosure. Furthermore, the effects described in the present specification are merely examples and are not restrictive, and some other effects may be achieved.

Further, the present disclosure can have configurations as described below.

(1)

A transmission device including:
a generation unit that generates physical layer control information included in a physical layer frame; and
a transmission unit that transmits the physical layer frame as a broadcast signal to which a layered division multiplexing system is applied,
in which a broadcast signal of a first broadcast system is transmitted in a first hierarchical layer of the layered division multiplexing system, and a broadcast signal of a second broadcast system is transmitted in a second hierarchical layer of the layered division multiplexing system, and,
of the physical layer control information, first physical layer control information included in the broadcast signal of the first broadcast system includes time information to be used in a synchronization process related to the broadcast signal of the second broadcast system.
   (2)

The transmission device according to (1),
in which the time information includes time information in an NTP format, and includes at least a transmission timestamp and a leap second indicator.
   (3)

The transmission device according to (2),
in which the time information further includes an NTP version and an operation mode.
   (4)

The transmission device according to (1),
in which the time information indicates time of a head of a physical layer frame next to the physical layer frame including the time information.
   (5)

The transmission device according to (1),
in which the first broadcast system includes ISDB-T,
the first physical layer control information includes an AC signal specified by ISDB-T, and
the time information is included in an extended area obtained by extending an unused area excluding an area used for seismic-motion alert information of the AC signal.
   (6)

The transmission device according to (5),
in which the extended area further includes at least one kind of control information among a plurality of kinds of control information to be used in processing related to the broadcast signal of the second broadcast system, and other information including information designated by a broadcaster.
   (7)

The transmission device according to any one of (1) to (6),
in which the first broadcast system includes ISDB-T,
the second broadcast system includes a next-generation system of ISDB-T, and
the broadcast signal of ISDB-T is transmitted in a high-power hierarchical layer of the layered division multiplexing system, and the broadcast signal of the next-generation system of ISDB-T is transmitted in a low-power hierarchical layer of the layered division multiplexing system.
   (8)

A transmission method implemented by a transmission device, the transmission method including:
generating physical layer control information included in a physical layer frame; and
transmitting the physical layer frame as a broadcast signal to which a layered division multiplexing system is applied,
in which a broadcast signal of a first broadcast system is transmitted in a first hierarchical layer of the layered division multiplexing system, and a broadcast signal of a second broadcast system is transmitted in a second hierarchical layer of the layered division multiplexing system; and,
of the physical layer control information, time information to be used in a synchronization process related to the broadcast signal of the second broadcast system is included in first physical layer control information included in the broadcast signal of the first broadcast system.
   (9)

A reception device including:
a reception unit that receives a physical layer frame transmitted as a broadcast signal to which a layered division multiplexing system is applied; and
a processing unit that processes data obtained from the physical layer frame,
in which a broadcast signal of a first broadcast system is transmitted in a first hierarchical layer of the layered division multiplexing system, and a broadcast signal of a second broadcast system is transmitted in a second hierarchical layer of the layered division multiplexing system, and
a synchronization process related to the broadcast signal of the second broadcast system is performed using time information included in first physical layer control information included in the broadcast signal of the first broadcast system, the first physical layer control information being of physical layer control information included in the physical layer frame.
   (10)

The reception device according to (9),
in which the time information includes time information in an NTP format, and includes at least a transmission timestamp and a leap second indicator.
   (11)

The reception device according to (10),
in which the time information further includes an NTP version and an operation mode.
   (12)

The reception device according to (9),
in which the time information indicates time of a head of a physical layer frame next to the physical layer frame including the time information.
   (13)

The reception device according to (9),
in which the first broadcast system includes ISDB-T,
the first physical layer control information includes an AC signal specified by ISDB-T, and
the time information is included in an extended area obtained by extending an unused area excluding an area used for seismic-motion alert information of the AC signal.
   (14)

The reception device according to (13),
in which the extended area further includes at least one kind of control information among a plurality of kinds of control information to be used in processing related to the broadcast signal of the second broadcast system, and other information including information designated by a broadcaster.
   (15)

The reception device according to any one of (9) to (14),
in which the first broadcast system includes ISDB-T,
the second broadcast system includes a next-generation system of ISDB-T, and
the broadcast signal of ISDB-T is transmitted in a high-power hierarchical layer of the layered division multiplexing system, and the broadcast signal of the next-generation system of ISDB-T is transmitted in a low-power hierarchical layer of the layered division multiplexing system.
   (16)

A reception method implemented by a reception device, the reception method including:
receiving a physical layer frame transmitted as a broadcast signal to which a layered division multiplexing system is applied;
processing data obtained from the physical layer frame,
in which a broadcast signal of a first broadcast system is transmitted in a first hierarchical layer of the layered division multiplexing system, and a broadcast signal of a second broadcast system is transmitted in a second hierarchical layer of the layered division multiplexing system; and
performing a synchronization process related to the broadcast signal of the second broadcast system using time information included in first physical layer control information included in the broadcast signal of the first broadcast system, the first physical layer control information being of physical layer control information included in the physical layer frame.
   (17)

A transmission device including:
a generation unit that generates physical layer control information included in a physical layer frame; and
a transmission unit that transmits the physical layer frame as a broadcast signal to which a layered division multiplexing system is applied,
in which a first stream including data of content is transmitted in a first hierarchical layer between the first hierarchical layer and a second hierarchical layer of the layered division multiplexing system, and
the physical layer control information includes timeline synchronization information for synchronizing, in time series, data included in the first stream and data included in a second stream of a system different from the first stream.
   (18)

The transmission device according to (17),
in which the first stream includes data serving as a base when providing the content of a predetermined video quality, and
the second stream including additional data for enhancing video quality of the content is transmitted in the second hierarchical layer.
   (19)

The transmission device according to (17),
in which the second stream is transmitted through a communication path.
   (20)

The transmission device according to any one of (17) to (19),
in which the first stream includes a stream including a packet in an MPEG2-TS format,
the second stream includes a stream including a packet in an IP format, and
the timeline synchronization information includes UTC in an NTP format compatible with PCR to be used in the MPEG2-TS format.
   (21)

A transmission method implemented by a transmission device, the transmission method including:
generating physical layer control information included in a physical layer frame; and
transmitting the physical layer frame as a broadcast signal to which a layered division multiplexing system is applied,
in which a first stream including data of content is transmitted in a first hierarchical layer between the first hierarchical layer and a second hierarchical layer of the layered division multiplexing system, and
the physical layer control information includes timeline synchronization information for synchronizing, in time series, data included in the first stream and data included in a second stream of a system different from the first stream.
   (22)

A reception device including:
a reception unit that receives a physical layer frame transmitted as a broadcast signal to which a layered division multiplexing system is applied; and
a processing unit that processes data obtained from the physical layer frame,
in which a first stream including data of content is transmitted in a first hierarchical layer between the first hierarchical layer and a second hierarchical layer of the layered division multiplexing system, and
a synchronization process of synchronizing, in time series, data included in the first stream and data included in a second stream of a system different from the first stream is performed using timeline synchronization information included in physical layer control information included in the physical layer frame.
   (23)

The reception device according to (22),
in which the first stream includes data serving as a base when providing the content of a predetermined video quality, and
the second stream including additional data for enhancing video quality of the content is transmitted in the second hierarchical layer.
   (24)

The reception device according to (22),
in which the second stream is transmitted through a communication path.
   (25)

The reception device according to any one of (22) to (24),
in which the first stream includes a stream including a packet in an MPEG2-TS format,
the second stream includes a stream including a packet in an IP format, and
the timeline synchronization information includes UTC in an NTP format compatible with PCR to be used in the MPEG2-TS format.
   (26)

A reception method implemented by a reception device, the reception method including:
receiving a physical layer frame transmitted as a broadcast signal to which a layered division multiplexing system is applied;
processing data obtained from the physical layer frame,
in which a first stream including data of content is transmitted in a first hierarchical layer between the first hierarchical layer and a second hierarchical layer of the layered division multiplexing system; and
performing a synchronization process for synchronizing, in time series, data included in the first stream and data included in a second stream of a system different from the first stream using timeline control information included in the physical layer frame.

### REFERENCE SIGNS LIST

10 Transmission device
20 Reception device
30 Video encoding device
101 Generation unit
102 Transmission unit
201 Reception unit
202 Processing unit
1001 CPU

1. A transmission device comprising:
a generation unit that generates physical layer control information included in a physical layer frame; and
a transmission unit that transmits the physical layer frame as a broadcast signal to which a layered division multiplexing system is applied,
wherein a broadcast signal of a first broadcast system is transmitted in a first hierarchical layer of the layered division multiplexing system, and a broadcast signal of a second broadcast system is transmitted in a second hierarchical layer, and,
of the physical layer control information, first physical layer control information included in the broadcast signal of the first broadcast system includes time information to be used in a synchronization process related to the broadcast signal of the second broadcast system.

2. The transmission device according to claim 1,
wherein the time information includes time information in an NTP format, and includes at least a transmission timestamp and a leap second indicator.

3. The transmission device according to claim 2, wherein
the time information further includes an NTP version and an operation mode.

4. The transmission device according to claim 1,
wherein the time information indicates time of a head of a physical layer frame next to the physical layer frame including the time information.

5. The transmission device according to claim 1,
wherein the first broadcast system includes ISDB-T,
the first physical layer control information includes an AC signal specified by ISDB-T, and
the time information is included in an extended area obtained by extending an unused area excluding an area used for seismic-motion alert information of the AC signal.

6. The transmission device according to claim 5,
wherein the extended area further includes at least one kind of control information among a plurality of kinds of control information to be used in processing related to the broadcast signal of the second broadcast system, and other information including information designated by a broadcaster.

7. The transmission device according to claim 1,
wherein the first broadcast system includes ISDB-T,
the second broadcast system includes a next-generation system of ISDB-T, and
the broadcast signal of ISDB-T is transmitted in a high-power hierarchical layer of the layered division multiplexing system, and the broadcast signal of the next-generation system of ISDB-T is transmitted in a low-power hierarchical layer of the layered division multiplexing system.

8. A transmission method implemented by a transmission device, the transmission method comprising:
generating physical layer control information included in a physical layer frame; and
transmitting the physical layer frame as a broadcast signal to which a layered division multiplexing system is applied,
wherein a broadcast signal of a first broadcast system is transmitted in a first hierarchical layer of the layered division multiplexing system, and a broadcast signal of a second broadcast system is transmitted in a second hierarchical layer of the layered division multiplexing system, and
of the physical layer control information, time information to be used in a synchronization process related to the broadcast signal of the second broadcast system is included in first physical layer control information included in the broadcast signal of the first broadcast system.

9. A reception device comprising:
a reception unit that receives a physical layer frame transmitted as a broadcast signal to which a layered division multiplexing system is applied; and
a processing unit that processes data obtained from the physical layer frame,
wherein a broadcast signal of a first broadcast system is transmitted in a first hierarchical layer of the layered division multiplexing system, and a broadcast signal of a second broadcast system is transmitted in a second hierarchical layer of the layered division multiplexing system, and
a synchronization process related to the broadcast signal of the second broadcast system is performed using time information included in first physical layer control information included in the broadcast signal of the first broadcast system, the first physical layer control information being of physical layer control information included in the physical layer frame.

10. The reception device according to claim 9
wherein the time information includes time information in an NTP format, and includes at least a transmission timestamp and a leap second indicator.

11. The reception device according to claim 10,
wherein the time information further includes an NTP version and an operation mode.

12. The reception device according to claim 9,
wherein the time information indicates time of a head of a physical layer frame next to the physical layer frame including the time information.

13. The reception device according to claim 9,
wherein the first broadcast system includes ISDB-T,
the first physical layer control information includes an AC signal specified by ISDB-T, and
the time information is included in an extended area obtained by extending an unused area excluding an area used for seismic-motion alert information of the AC signal.

14. The reception device according to claim 13,
wherein the extended area further includes at least one kind of control information among a plurality of kinds of control information to be used in processing related to the broadcast signal of the second broadcast system, and other information including information designated by a broadcaster.

15. The reception device according to claim 9,
wherein the first broadcast system includes ISDB-T,
the second broadcast system includes a next-generation system of ISDB-T, and
the broadcast signal of ISDB-T is transmitted in a high-power hierarchical layer of the layered division multiplexing system, and the broadcast signal of the next-generation system of ISDB-T is transmitted in a low-power hierarchical layer of the layered division multiplexing system.

16. A reception method implemented by a reception device, the reception method comprising:
receiving a physical layer frame transmitted as a broadcast signal to which a layered division multiplexing system is applied;
processing data obtained from the physical layer frame,
wherein a broadcast signal of a first broadcast system is transmitted in a first hierarchical layer of the layered division multiplexing system, and a broadcast signal of a second broadcast system is transmitted in a second hierarchical layer of the layered division multiplexing system; and
performing a synchronization process related to the broadcast signal of the second broadcast system using time information included in first physical layer control information included in the broadcast signal of the first broadcast system, the first physical layer control information being of physical layer control information included in the physical layer frame.

17. A transmission device comprising:
a generation unit that generates physical layer control information included in a physical layer frame; and
a transmission unit that transmits the physical layer frame as a broadcast signal to which a layered division multiplexing system is applied,
wherein a first stream including data of content is transmitted in a first hierarchical layer between the first hierarchical layer and a second hierarchical layer of the layered division multiplexing system, and
the physical layer control information includes timeline synchronization information for synchronizing, in time series, data included in the first stream and data included in a second stream of a system different from the first stream.

18. The transmission device according to claim 17,
wherein the first stream includes data serving as a base when providing the content of a predetermined video quality, and
the second stream including additional data for enhancing video quality of the content is transmitted in the second hierarchical layer.

19. The transmission device according to claim 17,
wherein the second stream is transmitted through a communication path.

20. The transmission device according to claim 17,
wherein the first stream includes a stream including a packet in an MPEG2-TS format,
the second stream includes a stream including a packet in an IP format, and
the timeline synchronization information includes UTC in an NTP format compatible with PCR to be used in the MPEG2-TS format.

21. A transmission method implemented by a transmission device, the transmission method comprising:
generating physical layer control information included in a physical layer frame; and
transmitting the physical layer frame as a broadcast signal to which a layered division multiplexing system is applied,
wherein a first stream including data of content is transmitted in a first hierarchical layer between the first hierarchical layer and a second hierarchical layer of the layered division multiplexing system, and
the physical layer control information includes timeline synchronization information for synchronizing, in time series, data included in the first stream and data included in a second stream of a system different from the first stream.

22. A reception device comprising:
a reception unit that receives a physical layer frame transmitted as a broadcast signal to which a layered division multiplexing system is applied; and
a processing unit that processes data obtained from the physical layer frame,
wherein a first stream including data of content is transmitted in a first hierarchical layer between the first hierarchical layer and a second hierarchical layer of the layered division multiplexing system, and
a synchronization process of synchronizing, in time series, data included in the first stream and data included in a second stream of a system different from the first stream is performed using timeline synchronization information included in physical layer control information included in the physical layer frame.

23. The reception device according to claim 22,
wherein the first stream includes data serving as a base when providing the content of a predetermined video quality, and
the second stream including additional data for enhancing video quality of the content is transmitted in the second hierarchical layer.

24. The reception device according to claim 22,
wherein the second stream is transmitted through a communication path.

25. The reception device according to claim 22,
wherein the first stream includes a stream including a packet in an MPEG2-TS format,
the second stream includes a stream including a packet in an IP format, and
the timeline synchronization information includes UTC in an NTP format compatible with PCR to be used in the MPEG2-TS format.

26. A reception method implemented by a reception device, the reception method comprising:
receiving a physical layer frame transmitted as a broadcast signal to which a layered division multiplexing system is applied;
processing data obtained from the physical layer frame,
wherein a first stream including data of content is transmitted in a first hierarchical layer between the first hierarchical layer and a second hierarchical layer of the layered division multiplexing system; and
performing a synchronization process for synchronizing, in time series, data included in the first stream and data included in a second stream of a system different from the first stream using timeline control information included in the physical layer frame.
